(19) United States
(12) Patent Application Publication
(10) Pub. No.: US 2014/0374644 A1
(43) Pub. Date: Dec. 25, 2014

(54) MAGNETIC MATERIAL AND DEVICE

(71) Applicant: Kabushiki Kaisha Toshiba, Minato-ku (JP)

(72) Inventors: Tomoko EGUCHI, Chuo-ku (JP); Seiichi Suenaga, Yokohama-shi (JP); Koichi Harada, Bunkyo-ku (JP); Tomohiro Suetsuna, Kawasaki-shi (JP); Toshihide Takahashi, Yokohama-shi (JP)

(73) Assignee: Kabushiki Kaisha Toshiba, Minato-ku (JP)

(21) Appl. No.: 14/311,672

(22) Filed: Jun. 23, 2014

(30) Foreign Application Priority Data
Jun. 25, 2013 (JP) 2013-133106

(51) Int. Cl. H01F 1/01

(52) U.S. Cl. CPC H01F 1/01
USPC 252/62.54

(57) ABSTRACT

A magnetic material of an embodiment includes a plurality of magnetic metal particles and a matrix phase. Each of the plurality of magnetic metal particles includes a magnetic metal and a first compound included in the magnetic metal. The magnetic metal includes at least one element selected from Fe, Co, and Ni. The first compound is an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr. The matrix phase fills a space between the plurality of magnetic metal particles and has higher electric resistance than the plurality of magnetic metal particles.

### CROSS-REFERENCE TO RELATED APPLICATION

This application is based upon and claims the benefit of priority from Japanese Patent Application No. 2013-133106, filed on Jun. 25, 2013, the entire contents of which are incorporated herein by reference.

### FIELD

Embodiments described herein relate generally to a magnetic material and a device.

### BACKGROUND

At present, a magnetic material is used in various devices such as an inductor, an electromagnetic wave absorber, magnetic ink, and an antenna device, and is a very important material. These devices utilize the magnetic permeability or the characteristic of the magnetic loss of the magnetic material in accordance with the purpose. The magnetic loss includes the loss by the ferromagnetic resonance, the loss by the magnetic domain wall resonance, the eddy current loss by the induced current when the magnetic field is applied, and the hysteresis loss as the thermal energy loss in the magnetizing process. The inductor and the antenna device utilize the high magnetic permeability and the low magnetic loss, and the electromagnetic wave absorber utilizes the high magnetic loss. Thus, in the case of utilizing the material for the device actually, the magnetic permeability and the magnetic loss should be controlled in accordance with the frequency band used by the appliance.

The magnetic material with the high magnetic permeability and the low magnetic loss has attracted attention in the application to the power inductor employed in the power semiconductor device. The power semiconductor is the semiconductor used for controlling the high electric power and energy with high efficiency and is represented by a MOSFET and a power diode, etc. From the viewpoint of the reduction of the energy consumption, the power semiconductor has been widely used for various appliances including home appliances, computers, and automobiles.

At present, Si is mainly used as the material for the power semiconductor. To achieve the higher efficiency and size reduction of the appliance, however, it is considered that the use of SiC and GaN is effective. SiC and GaN have a larger band gap, a higher breakdown field, and a higher withstand voltage than Si, and can therefore provide a thinner element. For this reason, the on resistance of the semiconductor can be reduced and the loss can be reduced and the efficiency can be increased. In addition, since SiC and GaN have high carrier mobility, the switching frequency can be increased and the element can be reduced in size. The driving frequency of the system is predicted to be increased from the kHz band of Si to the MHz band.

In view of the above, the power semiconductor including SiC and GaN have been extensively developed. To mount the power semiconductor in various appliances, it is essential to develop the power inductor, i.e., the magnetic material with the high magnetic permeability and the low magnetic loss in the MHz band. In addition, the saturation magnetization that can deal with large current is necessary. When the saturation magnetization is high, it is difficult for the magnetic saturation to occur even in the application of a high magnetic field, and the deterioration in the effective inductance value can be suppressed, which improves the DC superimposition characteristic of the device and improves the efficiency of the system.

The magnetic material that a put into practical use as the inductor at present includes a metal-based material such as a silicon steel plate or FINEMET (registered trademark) (a microcrystalline material manufactured by Hitachi Metals, Ltd.) and an oxide material represented by ferrite. The metal material has high saturation magnetization and high magnetic permeability; however, the electric resistance thereof is low and the eddy current loss is increased in the high frequency band of 1 MHz or more. The oxide material has the low magnetic loss even in the high frequency band because the material itself has high electric resistance; however, since the saturation magnetization thereof is low, the magnetization easily saturates and the inductance value is decreased. Thus, the oxide material is not suitable for the power inductor.

As the inductor for the power semiconductor such as SiC and GaN, the development of the magnetic material that satisfies the high saturation magnetization, the high magnetic permeability, and the low magnetic loss in the MHz band of 1 MHz or more is essential.

In addition, the magnetic material with the high magnetic permeability and the low magnetic loss in the high frequency band is expected to be used for the application not just as the power inductor but also as the device of the high frequency communication appliance such as the antenna device. As a method of reducing the size and the power consumption of the antenna, a method is given in which an insulation substrate with high magnetic permeability and low magnetic loss is used as an antenna substrate, and the electric wave is transmitted and received while absorbing the electrical wave which is expected to reach the electronic component and the substrate so that the electric wave is not reached to the electric component. This method enables to reduce the size and the power consumption of the antenna; additionally, the resonance frequency of the antenna can be increased at the same time, which is preferable. Thus, if the magnetic material for the power inductor is developed, the material can also be applied to the antenna device.

In addition, the electromagnetic wave absorber utilizes the high magnetic loss to absorb the noise generated from the electronic appliance, whereby the trouble such as the malfunction of the electronic appliance is reduced. Since the electronic appliance is used in various frequency bands, the high magnetic loss is required in a predetermined frequency band. The magnetic material generally shows the high magnetic loss near the ferromagnetic resonance frequency. The ferromagnetic resonance frequency of the magnetic material with the low loss in the MHz band is generally a GHz band. Thus, the magnetic material for the MHz-band power inductor can also be applied to the electric wave absorber used in the GHz band, for example.

In this way, if the material with the high magnetic permeability and the low magnetic loss in the MHz band can be developed, the material can be used for the power inductor, the antenna device, the electromagnetic wave absorber, and the like of the high frequency band of the MHz band or more. However, the magnetic materials suggested previously do not necessarily have the sufficient characteristics.

### BRIEF DESCRIPTION OF THE DRAWINGS

FIG. 1 is a schematic view of a magnetic material according to a first embodiment;

FIG. 2 is a schematic view of a magnetic material according to a second embodiment;

FIG. 3 is a schematic view of a magnetic material according to a third embodiment;

FIGS. 4A and 4B are conceptual diagrams of a device according to a fifth embodiment;

FIGS. 5A and 5B are conceptual diagrams of the device according to the fifth embodiment; and

FIG. 6 is a conceptual diagram of the device according to the fifth embodiment.

### DETAILED DESCRIPTION

A magnetic material of an embodiment includes : a plurality of magnetic metal particles, each of the plurality of magnetic metal particles including a magnetic metal and a first compound included in the magnetic metal, the magnetic metal including at least one element selected from Fe, Co, and Ni, the first compound being an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr; and a matrix phase filling a space between the plurality of magnetic metal particles, the matrix phase having higher electric resistance than the plurality of magnetic metal particles.

An embodiment of the present disclosure is described with reference to the drawings.

The present inventors have found out that when the magnetic material contains a compound, which is an oxide, a nitride, or a carbide, inside the magnetic metal particle, the strength and internal resistance of the magnetic metal particle are increased and the magnetic material with excellent characteristics of the high saturation magnetization, the high magnetic permeability, and the low magnetic loss in the high frequency band can be easily manufactured. The present disclosure has been made based on the knowledge obtained by the present inventors.

### First Embodiment

A magnetic material of this embodiment includes : a plurality of magnetic metal particles, each of the plurality of magnetic metal particles including a magnetic metal and a first compound included in the magnetic metal, the magnetic metal including at least one element selected from Fe, Co, and Ni, the first compound being an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr; and a matrix phase filling a space between the plurality of magnetic metal particles, the matrix phase having higher electric resistance than the plurality of magnetic metal particles.

By including the above structure, the magnetic material of this embodiment achieves the high saturation magnetization, the high magnetic permeability, and the low magnetic loss in the MHz band of 1 MHz or more.

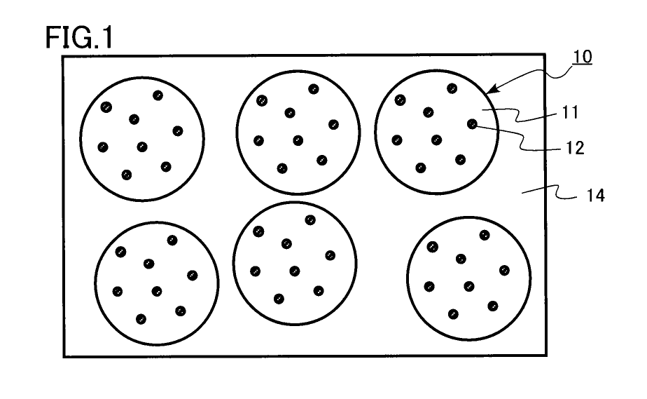

FIG. 1 is a sectional schematic view of the magnetic material of this embodiment. The magnetic material of this embodiment includes magnetic metal particles 10 and a matrix phase 14. The magnetic metal particle 10 includes a magnetic metal 11, and a first compound 12 included in the magnetic metal 11.

The magnetic metal 11 is a magnetic metal including at least one element selected from Fe, Co, and Ni. The magnetic metal 11 may be a single metal of Fe, Co, and Ni. The magnetic metal 11 may be an alloy such as Fe-based alloy, Co-based alloy, FeCo-based alloy, or FeNi-based alloy. The Fe-based alloy may be, for example, FeNi alloy, FeMn alloy, or FeCu alloy. The Co-based alloy may be, for example, CoNi alloy, CoMn alloy, or CoCu alloy. The FeCo-based alloy may be, for example, FeCoNi, FeCoMn, or FeCoCu alloy.

The magnetic metal particle 10 is a spherical particle and the magnetic metal 11 is polycrystalline or amorphous.

The first compound 12 is an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr. The first compound 12 is present at the crystal boundary or in the amorphous state of the magnetic metal 11 of the magnetic metal particle 10.

The matrix phase 14 has higher electric resistance than the magnetic metal particle 10. The matrix phase 14 is preferably the material with high electric resistance from the viewpoint of suppressing the eddy current loss by the eddy current flowing throughout the material. For example, air, glass, an organic resin, an oxide, a nitride, a carbide, or the like is given. The resistance value of the material of the matrix phase 14 is preferably 1 mΩ·cm or more.

Whether the matrix phase 14 has higher electric resistance than the magnetic metal particle 10 can be determined by the four-terminal method or two-terminal method electric resistance measurement in which the electric resistance is obtained from the current and voltage between the terminals. For example, the electric resistance is measured in a manner that a terminal (probe) is brought into contact with each of the magnetic metal particle and the matrix phase while the electron image of the sample where the magnetic metal particle and the matrix phase are mixed is observed with a scanning electronic microscope.

The magnetic material of this embodiment can have the low magnetic loss because the inclusion of the first compound 12 with higher electric resistance than the magnetic metal 11 in the magnetic metal particle 10 can suppress the eddy current in the magnetic metal particle 10.

In addition, since the first compound 12 is present at the crystal boundary of the magnetic metal 11, the diffusion of oxygen beyond the boundary is suppressed. Thus, the oxidation of the magnetic metal 11 is suppressed and the highly reliable magnetic material is achieved.

The rigidity of the first compound 12 is desirably higher than that of the magnetic metal 11. The high mechanical strength can be obtained by the inclusion of the first compound 12 with higher rigidity than the magnetic metal 11 in the magnetic metal particle 10.

At the section of the magnetic metal particle 10, the proportion A of the area of the first compound 12 in the magnetic metal particle 10 is preferably 0.1%≦A≦20%. When the area of the first compound 12 is greater than 20%, the magnetization of the entire magnetic material maybe decreased. When the area of the first compound 12 is less than 0.1%, the sufficient mechanical strength and reliability and the low magnetic loss may not be obtained.

The proportion A of the area of the first compound 12 is, for example, calculated by the observation of the section with a TEM or the like. For example, the border is determined by the image processing for the magnetic metal 11 and the oxide 12 from the TEM image and then the proportion of the area can be obtained.

When it is difficult to determine the border just by the image processing, etc., the proportion A of the area of the first compound 12 is calculated by observing the section of the magnetic metal particle 10 with a transmission electron microscope (TEM) and an energy dispersive X-ray spectrometry (EDX). The sectional TEM image of the magnetic metal particle 10 is irradiated with EDX to perform the element mapping, and the pieces of information obtained from the sectional TEM image and the element mapping are integrated to lead A′=particle sectional area where oxygen, nitrogen, or carbon is detected/sectional area of magnetic metal particle 10. A is the average value of A′ of any ten magnetic metal particles.

The volume ratio of the magnetic metal particle 10 in the magnetic material is desirably 20% or more and 80% or less of the entire magnetic material. When the volume ratio is greater than 80%, the electric resistance of the entire magnetic material is reduced, which may cause the fact that the eddy current loss by the eddy current flowing throughout the sample is increased. When the volume ratio is less than 20%, the decrease in volume ratio of the magnetic metal may deteriorate the saturation magnetization of the magnetic material to cause the magnetic permeability deterioration.

The magnetic metal particle 10 preferably has an average particle diameter of 100 nm or more and 15 μm or less. In general, the eddy current loss is in proportion to the square of the frequency and the eddy current loss increases in the high frequency band. The diameter of the magnetic metal particle 10 which is larger than 15 μm is not preferable because the eddy current loss in the particle becomes remarkable at 1 MHz or more, and the ferromagnetic resonance frequency is decreased and the loss by the ferromagnetic resonance appears in the MHz band. The diameter of the magnetic metal particle 10 less than 100 nm is not preferable because the coercive force is large and the hysteresis loss is increased though the eddy current loss in the MHz band is small. In this way, to achieve the magnetic material with the low magnetic loss in the MHz band, the magnetic metal particle needs to be in the suitable diameter range. In addition, as the particle diameter of the magnetic metal particle is decreased, the saturation magnetization is decreased by natural oxidation. In this embodiment, by including the first compound 12 at the crystal boundary or in the amorphous state of the magnetic metal particle 10, the oxidation of the magnetic metal 11 by the diffusion of oxygen into the magnetic metal particle 10 is suppressed and the high saturation magnetization can be achieved in the magnetic metal particle with small diameter that is suitable for the MHz band. This can also achieve the high magnetic permeability. In this way, according to this embodiment, the magnetic material with the high saturation magnetization, the high magnetic permeability, and the low magnetic loss in the MHz band can be achieved.

When the magnetic material of this embodiment is manufactured, a high-power mill device is preferably used in the processing in a mill in order to include the compound (first compound) included in the magnetic metal particle. There are a method of mixing the magnetic metal and the compound in a mill so that the compound is mechanically included in the magnetic metal particle, a method of separating out an oxide, a nitride, or a carbide from a raw material containing oxygen, nitrogen, or carbon into Fe, Co, or Ni with a high-power mill, and the like. In the case of mixing the magnetic metal and the compound in the mill, the compound to be used preferably has a diameter of 5 nm or more and 100 nm or less. When the compound has a diameter of 5 nm or less, the internal resistance of the magnetic metal particle may not be increased sufficiently. When the compound has a diameter of greater than 100 nm, it may be difficult to have the compound included in the magnetic metal particle. The apparatus is not limited as long as the apparatus can apply high gravitational acceleration. For example, a rotary ball mill, a vibratory ball mill, a stirring ball mill (attritor), a bead mill, a planetary mill, a jet mill, and the like are given. The gravitational acceleration is preferably 40 G or more, particularly 100 G or more. The diameter of the ball or the bead to be used is preferably 0.1 mm or more and 10 mm or less. The diameter of the ball which is less than 0.1 mm is not preferable because it is difficult to collect the powder and to increase the yield. The diameter of the ball which is greater than 10 mm is not preferable because the contact between the ball and the magnetic metal particle becomes difficult and the compound may not be included in the magnetic metal particle. In the processing in the mill, a wet-type mill using solvent is preferable. This is because the use of the solvent enables the uniform particle synthesis.

### Second Embodiment

A magnetic material of this embodiment is similar to that of the first embodiment except that the magnetic metal particle further includes a second compound included in the magnetic metal, the second compound having higher electric resistance than the first compound, the second compound being an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr. The description on the content overlapping with the first embodiment is therefore omitted.

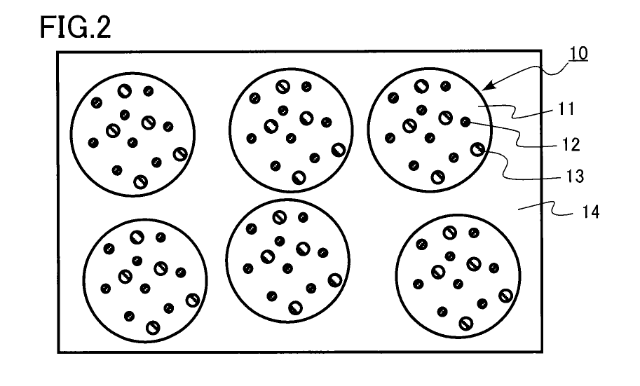

FIG. 2 is a sectional schematic view of the magnetic material of this embodiment. The magnetic material of this embodiment includes the magnetic metal particle 10 and the matrix phase 14. The magnetic metal particle 10 includes the magnetic metal 11, and the first compound 12 and a second compound 13 included in the magnetic metal 11.

The first compound 12 is, for example, iron oxide. The second compound 13 is a compound different from the first compound 12. The second compound 13 is, for example, alumina, which is an oxide of aluminum (Al).

The magnetic material of this embodiment can have higher internal resistance of the magnetic metal particle and lower eddy current loss because the second compound 13 with higher electric resistance than the first compound 12 is included in the magnetic metal particle. The strength of the magnetic material can be further increased when the second compound 13 has higher rigidity than the first compound 12. Therefore, the magnetic material with higher reliability can be achieved. By adjusting the amount of the second compound contained in addition to the first compound, it becomes easier to adjust the eddy current loss and the rigidity to the values suitable for the device usage condition.

Whether the electric resistance of the second compound 13 is higher than that of the first compound 12 can be determined using, for example, an atomic force microscope in a manner that a probe is brought into contact with the compounds 12 and 13 to measure the current and the voltage and the electric resistance is calculated therefrom.

### Third Embodiment

The magnetic material of this embodiment is similar to that of the first embodiment except that the magnetic metal particle is not a spherical particle but a flat particle. Thus, the description on the content overlapping with the first embodiment is omitted.

The magnetic metal particle 10 may be spherical but is more preferably flat. When the section of a flat particle taken along the longest diameter of the particle has a major-axis length of X and a minor-axis length of Y, 100 nm≦X≦15 μm and 20 nm≦Y≦7.5 μm are preferably satisfied and the aspect ratio X/Y is preferably 2 or more.

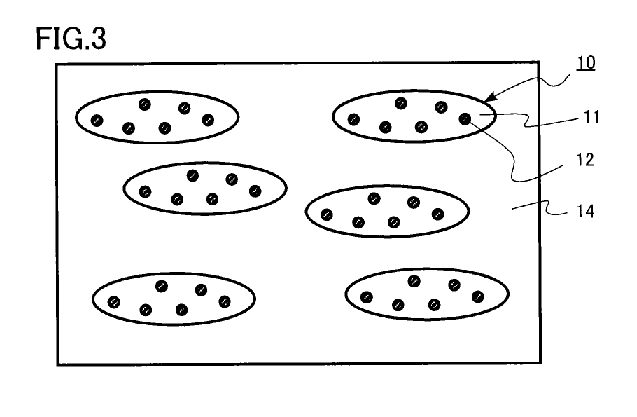

FIG. 3 is a schematic view of the magnetic material of this embodiment.

When the magnetic metal particle 10 is the flat particle with a high aspect ratio, the magnetic anisotropy (axis of easy magnetization, axis of hard magnetization) depending on the shape can be given. By having the axis of easy magnetization aligned in the longitudinal direction of the flat particle, the magnetic permeability can be increased. By the use of the flat particle, the filling ratio of the magnetic metal particle can be increased, and the saturation magnetization per unit volume or weight of the magnetic material is increased, whereby the material with the high saturation magnetization and high magnetic permeability can be obtained.

The major axis X with a length of greater than 15 μm is not preferable because the loss by the ferromagnetic resonance and the eddy current loss in the particle in the MHz band increase. The major axis X with a length of less than 100 nm is not preferable because the coercive force is large and the hysteresis loss is increased. When the minor axis Y has a length of greater than 7.5 μm, the aspect ratio becomes smaller and the effect of the high magnetic permeability may not be obtained. When the minor axis Y has a length of less than 20 nm, it is difficult to have the compound 12 included in the magnetic metal particle 10 and the sufficient strength or internal resistance may not be obtained.

The major axis X and the minor axis Y are observed using a transmission electron microscope (TEM). From the sectional TEM image taken along the longest diameter of the magnetic metal particle 10, the major-axis length and the minor-axis length of the particle are measured. Any ten magnetic metal particles are similarly subjected to the measurement, and the average value of the major-axis lengths is defined as X and the average value of the minor-axis lengths is defined as Y.

### Fourth Embodiment

The magnetic material of this embodiment is similar to that of the first embodiment except that aggregated magnetic metal particles are included. Thus, the description on the content overlapping with the first embodiment is omitted. The aggregated magnetic metal particles herein refer to the state that one or more magnetic metal particles 10 are in contact with another magnetic metal particle 10 without the matrix phase 14 interposed therebetween.

For example, the case is considered in which two magnetic metal particles (primary particles) with a diameter of 5 μm are aggregated to form a secondary particle with a longest diameter of 10 μm. Although the contact point between the particles is small, the particles show strong magnetic coupling. Therefore, the secondary particle exhibits the same magnetic properties as the magnetic metal particle (primary particle) with a diameter of 10 μm but the current flows less easily at the contact point between the particles. Therefore, the secondary particle with a diameter of 10 μm can have smaller coercive force, i.e., smaller hysteresis loss than the particle with a diameter of 5 μm and have the smaller eddy current loss than the magnetic metal particle (primary particle) with a diameter of 10 μm.

The aggregated magnetic metal particles 10 preferably include two or more and ten or less particles. The aggregation of more than ten particles is not desirable because the diameter of the secondary particle may be increased to deteriorate the ferromagnetic resonance frequency and the loss by the ferromagnetic resonance may be caused.

### Fifth Embodiment

A device of this embodiment includes the magnetic material described in the above embodiment. Thus, the description on the content overlapping with the above embodiments is omitted.

The device of this embodiment corresponds to, for example, a high frequency magnetic component such as an inductor, a choke coil, a filter, or a transformer, an antenna substrate or component, an electric wave absorber, or the like.

The inductor is the application that makes the best use of the magnetic material of the above embodiment. In particular, when the material is used in the power inductor to which high current is applied in the MHz band of 1 MHz or more, the effects of the high saturation magnetization, the high magnetic permeability, and the low magnetic loss of the magnetic material are easily exhibited.

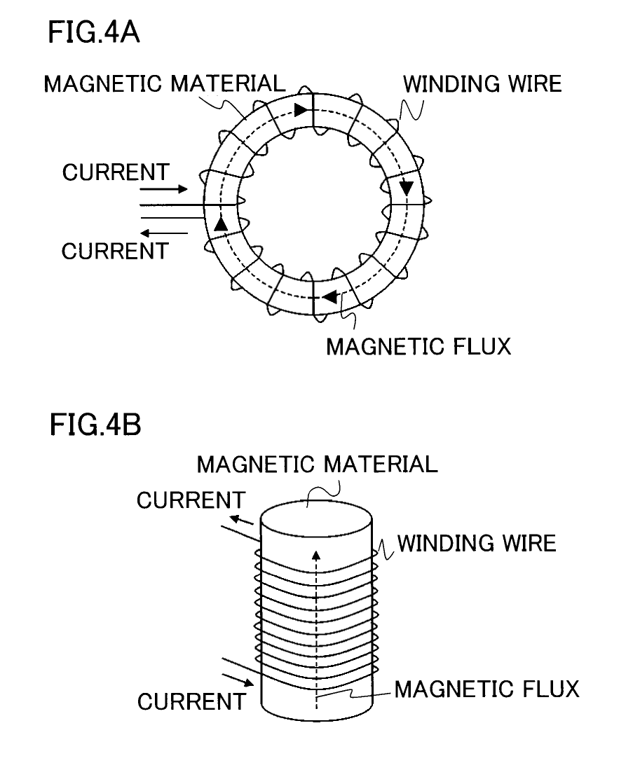

FIGS. 4A and 4B, FIGS. 5A and 5B, and FIG. 6 illustrate examples of the concept of the inductor of this embodiment.

As the most basic structure, the embodiment in which a coil wire is wound around a ring-shaped magnetic material as illustrated in FIG. 4A and the embodiment in which a coil wire is wound around a bar-shaped magnetic material as illustrated in FIG. 4B are given. For integrating the magnetic metal particle and the matrix phase in the ring shape or the bar shape, it is preferable to perform the press molding with a pressure of 0.1 kgf/cm² or more. When the pressure is less than 0.1 kgf/cm², the space inside a mold product increases to decrease the volume ratio of the magnetic metal particle, and the saturation magnetization and the magnetic permeability may be decreased. The press molding is performed by, for example, a uniaxial press molding method, a hot-press molding method, a CIP (cold isostatic press) method, an HIP (hot isostatic press) method, or an SPS (spark plasma sintering) method. The magnetic material of this embodiment can have high strength by the inclusion of the compound inside the magnetic metal particle; therefore, the device of this embodiment has the less fragile molded body and accordingly has the high reliability.

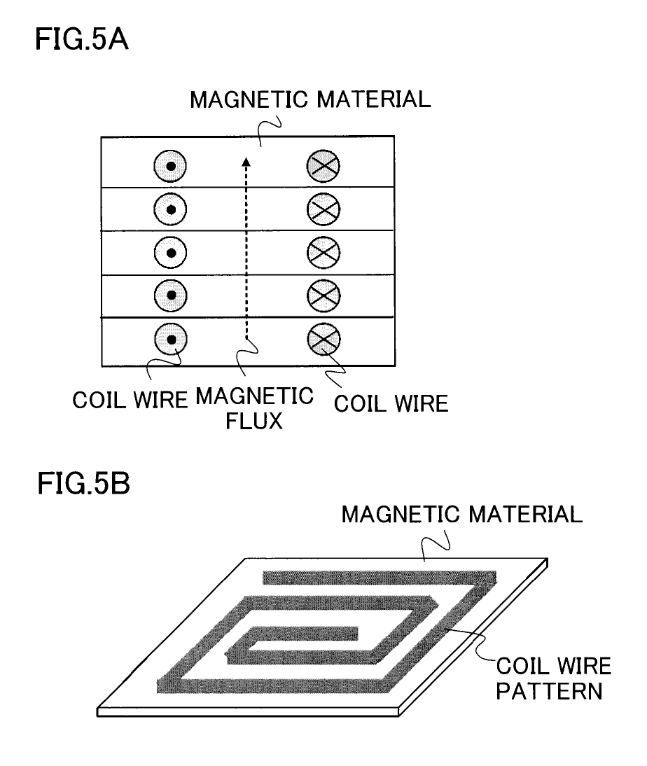

Moreover, a chip inductor in which the coil wire and the magnetic material are unified as illustrated in FIG. 5A or a planar inductor as illustrated in FIG. 5B can be obtained. The chip inductor may be a stacked type as illustrated in FIG. 5A.

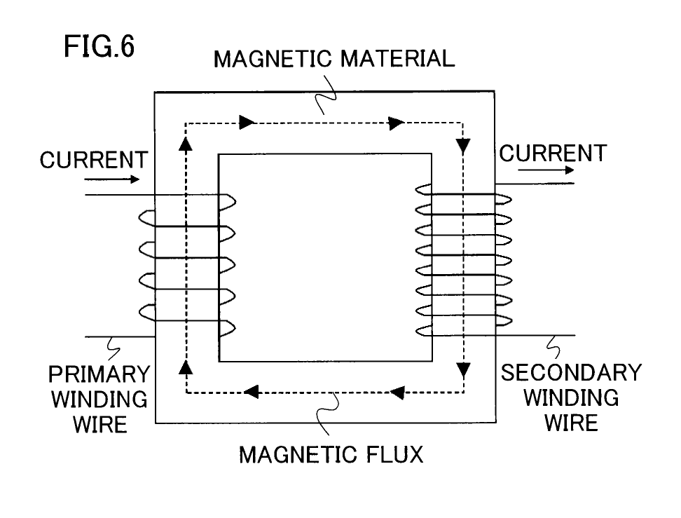

FIG. 6 illustrates an inductor of a transformer structure.

FIGS. 4 to 6 merely illustrate the typical structures and, actually, the structure and the size are preferably changed according to the application and the required inductor characteristic.

In the present embodiment, the device with excellent characteristics can be achieved by the use of the magnetic material with the high saturation magnetization, the high magnetic permeability, the low magnetic loss, and the high strength in the MHz band of 1 MHz or more.

### EXAMPLES

Examples of the present disclosure will be described.

### Example 1

Fe particles with a particle diameter of 3 μm and acetone were put into a planetary mill in which a ZrO₂ vessel and a ZrO₂ ball were used, and mill processing was performed for 10 hours at 1000 rpm under the Ar atmosphere. Thus, a magnetic metal particle in which the magnetic metal was Fe and the first compound included in the particle was iron oxide was obtained. The magnetic metal particle was 100 nm in diameter. As a result of observing the section of this magnetic metal particle with the transmission electron microscope (TEM), the proportion of the area of the iron oxide included in the particle was 0.1% on average. A ring-shaped evaluation material was fabricated by mixing and press-molding this magnetic metal particle and vinyl resin at a weight ratio of 100:10.

As a result of measuring the magnitude of magnetization of this evaluation material relative to the applied magnetic field using a vibrating sample magnetometer (VSM), the saturation magnetization was 1.0 T.

A copper wire was wound around this evaluation material for 40 times and the relative magnetic permeability and the magnetic loss (core loss) at 1 MHz were measured using B-H analyzer SY-8232 manufactured by IWATSU TEST INSTRUMENT CORPORATION. In the case of measuring the magnetic loss, the condition of the magnetic flux density needs to be decided in accordance with the magnetic permeability of the material. The formula B²=μLI²/V holds where B is the magnetic flux density, p is the magnetic permeability, L is the inductance, I is the current, and V is the volume. In this example, the condition of the magnetic flux density of each material was decided so that L, I, and V were constant and B=9.38 mT when μ=10 (for example, if μ=5, B=6.63 mT). The evaluation material fabricated as above had a relative magnetic permeability of 9.1 and a magnetic loss of 0.71 W/cc. The measurement results are shown in Table 1.

### Comparative Example 1

Fe particles with a particle diameter of 100 nm and vinyl resin were mixed at a weight ratio of 100:10 and a ring-shaped evaluation material was fabricated by the press-molding. This magnetic metal particle is Fe and does not include the first compound in the particle. This evaluation material was subjected to the measurement in a manner similar to Example 1, and the results are shown in Table 1.

### Example 2

Fe particles with a particle diameter of 3 μm and ferric oxide with a particle diameter of 300 nm were mixed at a weight ratio of 100:8, and acetone was added thereto. The mixture was put into a planetary mill in which a ZrO₂ vessel and a ZrO₂ ball were used, and mill processing was performed for 10 hours at 2000 rpm under the Ar atmosphere. Thus, a magnetic metal particle in which the magnetic metal was Fe and the first compound included in the particle was iron oxide was obtained. The magnetic metal particle was 100 nm in diameter. An evaluation material was fabricated and measured in a manner similar to Example 1 except that this magnetic metal particle was used. The results are shown in Table 1.

### Example 3

An evaluation material was fabricated and measured in a manner similar to Example 2 except that Fe particles with a particle diameter of 3 μm and ferric oxide with a particle diameter of 300 nm were used at a weight ratio of 100:15. The results are shown in Table 1.

### Example 4

An evaluation material was fabricated and measured in a manner similar to Example 1 except that the weight ratio between the magnetic metal particle and the vinyl resin was set to 100:1.5. The results are shown in Table 1.

### Example 5

An evaluation material was fabricated and measured in a manner similar to Example 1 except that the weight ratio between the magnetic metal particle and the vinyl resin was set to 100:20. The results are shown in Table 1.

### Example 6

An evaluation material was fabricated and measured in a manner similar to Example 1 except that the weight ratio between the magnetic metal particle and the vinyl resin was set to 100:1. The results are shown in Table 1.

### Example 7

An evaluation material was fabricated and measured in a manner similar to Example 1 except that the weight ratio between the magnetic metal particle and the vinyl resin was set to 100:25. The results are shown in Table 1.

### Example 8

Fe particles with a particle diameter of 50 μm and acetone were subjected to attritor processing for two hours under the Ar atmosphere. Thus, a magnetic metal particle in which the magnetic metal was Fe and the first compound included in the particle was iron oxide and whose diameter was 15 μm was obtained. An evaluation material was fabricated and measured in a manner similar to Example 1 except that this magnetic metal particle was used.

The results are shown in Table 1.

### Example 9

An evaluation material was fabricated and measured in a manner similar to Example 8 except that the processing time was set to an hour. The results are shown in Table 1.

### Example 10

An evaluation material was fabricated and measured in a manner similar to Example 1 except that the mill processing time was set to 20 minutes. The results are shown in Table 1.

### Example 11

An evaluation material was fabricated and measured in a manner similar to Example 1 except that the mill processing time was set to two hours. Two to ten of the magnetic metal particles were aggregated. The results are shown in Table 1.

### Example 12

Fe particles with a particle diameter of 3 μm and Al₂O₃ were mixed at a weight ratio of 100:2, and acetone was added thereto. The mixture was put into a planetary mill in which a ZrO₂ vessel and a ZrO₂ ball were used, and mill processing was performed for two hours at 700 rpm under the Ar atmosphere. Thus, a flat magnetic metal particle was obtained in which the magnetic metal was Fe, the first compound included in the particle was iron oxide, and the second compound was Al₂O₃. The flat magnetic metal particle was 10 μm in diameter and 200 nm in thickness. An evaluation material was fabricated and measured in a manner similar to Example 1 except that this magnetic metal particle was used. The results are shown in Table 1.

### Example 13

An evaluation material was fabricated and measured in a manner similar to Example 1 except that SiO₂ was used instead of Al₂O₃. The results are shown in Table 1.

TABLE 1

| | | | volume | | | | |
|---|---|---|---|---|---|---|---|
| | | | ratio of | | | | |
| | | | magnetic | diameter of | | | |
| | | area of | metal | magnetic | saturation | relative | |
| | | compound | particle | metal | magnetization | magnetic | magnetic |
| | compound | [%] | [%] | particle | [T] | permeability | loss [W/cc] |
| Example 1 | iron oxide | 0.1 | 46 | 100 nm | 1.0 | 9.1 | 0.71 |
| Comparative | none | 0 | 47 | 100 nm | 1.0 | 9.2 | 1.05 |
| Example 1 | | | | | | | |
| Example 2 | iron oxide | 20 | 25 | 100 nm | 0.54 | 8.0 | 0.85 |
| Example 3 | iron oxide | 25 | 20 | 100 nm | 0.38 | 6.5 | 0.86 |
| Example 4 | iron oxide | 0.1 | 80 | 100 nm | 1.7 | 15.5 | 0.75 |
| Example 5 | iron oxide | 0.1 | 20 | 100 nm | 0.43 | 7.1 | 0.69 |
| Example 6 | iron oxide | 0.1 | 85 | 100 nm | 1.8 | 16.0 | 0.99 |
| Example 7 | iron oxide | 0.1 | 15 | 100 nm | 0.32 | 6.5 | 0.84 |
| Example 8 | iron oxide | 0.1 | 46 | 15 μm | 1.0 | 12.0 | 0.89 |
| Example 9 | iron oxide | 0.1 | 46 | 20 μm | 1.0 | 13.0 | 0.95 |
| Example 10 | iron oxide | 0.1 | 40 | longest diameter 10 um | 0.86 | 10.5 | 0.69 |
| | | | | thickness 500 nm | | | |
| | | | | aspect ratio 20 | | | |
| Example 11 | iron oxide | 0.1 | 29 | longest diameter 8 um | 0.62 | 11.0 | 0.81 |
| | | | | thickness 100 nm | | | |
| | | | | aspect ratio 80 | | | |
| Example 12 | iron oxide | 5.5 | 33 | longest diameter 10 um | 0.71 | 8.7 | 0.51 |
| | Al2O3 | | | thickness 200 nm | | | |
| | | | | aspect ratio 50 | | | |
| Example 13 | iron oxide | 5.0 | 35 | longest diameter 10 um | 0.76 | 9.3 | 0.55 |
| | SiO2 | | | thickness 200 nm | | | |
| | | | | aspect ratio 50 | | | |

The magnetic metal particle according to any of Examples 1 to 13 includes the first compound or the first compound and the second compound inside the particle; as is clear from Table 1, the above particle has lower magnetic loss at 1 MHz than, and superior magnetic characteristic in the high frequency band to the particle of Comparative Example 1 that does not include the first compound.

The materials according to Examples 1, 2, 4, 5, and 8 in which the area of the compound in the magnetic metal particle is 0.1% or more and 20% or less, the volume ratio of the magnetic metal particle in the magnetic material is 20% or more and 80% or less and the diameter of the magnetic metal particle is 100 nm or more and 15 μm or less, have lower magnetic loss at 1 MHz than the materials according to Examples 6 and 9 and Comparative Example 1 in which any of the numerals is out of the above range.

In addition, the materials according to Examples 1, 2, 4, 5, and 8 have higher saturation magnetization and higher relative magnetic permeability and thus superior magnetic characteristic in the high frequency band than the materials according to Examples 3 and 7 in which any of the numerals is out of the above range.

The materials according to Examples 10 to 13 in which the magnetic metal particle is flat, the major-axis length of the particle is 100 nm or more and 15 μm or less, the minor-axis length is 20 nm or more and 7.5 μm or less, and the aspect ratio is 2 or more, have the magnetic loss at 1 MHz as low as the materials of Examples 1 to 9, and have the excellent magnetic characteristic in the high frequency band.

The materials according to Examples 12 and 13 including the first compound and the second compound in the magnetic metal particle have lower magnetic loss at 1 MHz than and superior magnetic characteristic in the high frequency band to the materials of Examples 10 and 11 that do not include the second compound.

While certain embodiments have been described, these embodiments have been presented by way of example only, and are not intended to limit the scope of the inventions. Indeed, the magnetic material and the device described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A magnetic material comprising:
a plurality of magnetic metal particles, each of the plurality of magnetic metal particles including a magnetic metal and a first compound included in the magnetic metal, the magnetic metal including at least one element selected from Fe, Co, and Ni, the first compound being an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr; and
a matrix phase filling a space between the plurality of magnetic metal particles, the matrix phase having higher electric resistance than the plurality of magnetic metal particles.

2. The magnetic material according to claim 1, wherein an average value of a proportion of an area of the first compound taken at a section of one of the plurality of magnetic metal particles is 0.1% or more and 20% or less.

3. The magnetic material according to claim 1, wherein a volume ratio of one of the plurality of magnetic metal particles in the magnetic material is 20% or more and 80% or less.

4. The magnetic material according to claim 1, wherein one of the plurality of magnetic metal particles has a particle diameter of 100 nm or more and 15 μm or less.

5. The magnetic material according to claim 1, wherein:
one of the plurality of magnetic metal particles is a flat particle; and
when a section of the flat particle taken along a longest diameter thereof has an average major-axis length of X and an average minor-axis length of Y, 100 nm≦X≦15 μm, 20 nm≦Y≦7.5 μm, and an aspect ratio X/Y being 2 or more are satisfied.

6. The magnetic material according to claim 1, wherein two or more and ten or less of the plurality of magnetic metal particles are aggregated.

7. The magnetic material according to claim 1, wherein the magnetic metal further includes a second compound, the second compound having higher electric resistance than the first compound, the second compound being an oxide, a nitride, or a carbide including at least one element selected from Fe, Al, Si, B, Mg, Ca, Zr, Ti, Hf, Zn, Mn, Nb, Ta, Mo, Cr, Cu, W, a rare-earth element, Ba, and Sr.

8. A device including the magnetic material according to claim 1.
